(19) United States
(12) Patent Application Publication
(10) Pub. No.: US 2024/0046773 A1
(43) Pub. Date: Feb. 8, 2024

(54) COMMUNICATION DEVICE, COMMUNICATION METHOD, COMMUNICATION SYSTEM, AND PROGRAM

(71) Applicant: SONY SEMICONDUCTOR SOLUTIONS CORPORATION, KANAGAWA (JP)

(72) Inventors: SHU SAIKAWA, KANAGAWA (JP); ATSUSHI MORI, KANAGAWA (JP); KATSUYA SHINOZAKI, KANAGAWA (JP)

(21) Appl. No.: 18/245,332

(22) PCT Filed: Sep. 17, 2021
(86) PCT No.: PCT/JP2021/034238

§ 371 Date: Oct. 17, 2023

(30) Foreign Application Priority Data
Oct. 2, 2020 (JP) 2020-167959

(51) Int. Cl. G08B 21/24

(52) U.S. Cl. CPC G08B 21/24

(57) ABSTRACT

The present disclosure relates to a communication device, a communication method, a communication system, and a program that enable recognition of a drop of the communication device. In a communication system including an earphone and a smartphone that perform Bluetooth (registered trademark) communication, when the earphone detects a drop, the earphone notifies the smartphone of the drop and transmits a drop position notification signal for providing a notification of its own position to the smartphone by the BLE communication. When notified of the drop of the smartphone, the smartphone vibrates a vibrator to notify the user that the earphone has dropped, and specifies and displays the position of the earphone on the basis of the drop position notification signal. The present disclosure can be applied to a communication system.

### TECHNICAL FIELD

The present disclosure relates to a communication device, a communication method, a communication system, and a program, and more particularly relates to a communication device, a communication method, a communication system, and a program capable of recognizing a drop of the communication device.

### BACKGROUND ART

Communication devices used for short-range communication typified by Bluetooth (registered trademark) are often small and lightweight devices such as earphones and headsets.

Since such a communication device is small and light, there has been a case where the communication device is lost due to dropping against the owner's will, or the like.

Accordingly, a technique has been proposed in which a tag is added to a communication device, communication for reading the tag is performed by a tag reader, and a drop of the communication device is notified by disconnection of the communication (see Patent Document 1).

### CITATION LIST

### Patent Document

Patent Document 1: Japanese Patent Application Laid-Open No. 2006-134242

### SUMMARY OF THE INVENTION

### Problems to be Solved by the Invention

However, in the technology of Patent Document 1, since the communication is not from the dropped communication device, the position cannot be specified on the basis of the communication from the communication device that is lost due to the dropping. For this reason, even if the user notices the drop of the communication device, the user cannot specify where the communication device has dropped and cannot find the dropped communication device in some cases.

The present disclosure has been made in view of such a situation, and makes it possible to recognize a drop by communication from a dropped communication device and to specify the position of the dropped communication device.

### Solutions to Problems

A communication device and a program of a first aspect of the present disclosure are a communication device and a program including a drop detection unit that detects presence or absence of a drop of an own device and transmits a notification indicating the drop when the drop is detected.

A communication method of the first aspect of the present disclosure is a communication method including the step of detecting presence or absence of a drop of an own device, and transmitting, when the drop is detected, a notification indicating that the drop has been detected.

In the first aspect of the present disclosure, presence or absence of a drop of the own device is detected, and when the drop is detected, a notification indicating the drop is transmitted.

A communication device and a program of a second aspect of the present disclosure are a communication device and a program including a reception unit that receives a notification indicating that a drop has been detected from another communication device, and a presentation unit that presents, on the basis of the notification, information indicating that the drop of the other communication device has been detected.

A communication method of the second aspect of the present disclosure is a communication method including the steps of receiving a notification indicating that a drop has been detected from another communication device, and presenting, on the basis of the notification, information indicating that the drop of the other communication device has been detected.

In the second aspect of the present disclosure, a notification indicating that a drop has been detected from another communication device is received, and on the basis of the notification, information indicating that the drop of the other communication device has been detected is presented.

A communication system of a third aspect of the present disclosure is a communication system including a first communication device and a second communication device that communicate with each other, in which the first communication device includes a drop detection unit that detects presence or absence of a drop of an own device and transmits a notification indicating that the drop has been detected to the second communication device when the drop is detected, and the second communication device includes a reception unit that receives the notification indicating that the drop has been detected from the first communication device, and a presentation unit that presents, on the basis of the notification, information indicating that the drop of the first communication device has been detected.

In the third aspect of the present disclosure, the first communication device detects presence or absence of a drop of an own device and transmits a notification indicating that the drop has been detected to the second communication device when the drop is detected, and the second communication device receives the notification indicating that the drop has been detected from the first communication device, and presents, on the basis of the notification, information indicating that the drop of the first communication device has been detected.

### BRIEF DESCRIPTION OF DRAWINGS

FIG. 1 is a diagram describing an outline of the present disclosure.

FIG. 2 is a diagram describing a configuration example of a communication system of the present disclosure.

FIG. 3 is a diagram describing a configuration example of a first embodiment of a smartphone of the present disclosure.

FIG. 4 is a diagram describing a configuration example of the first embodiment of an earphone of the present disclosure.

FIG. 5 is a flowchart describing drop notification processing according to the first embodiment of the present disclosure.

FIG. 6 is a flowchart describing drop event detection processing in FIG. 5.

FIG. 7 is a diagram describing a configuration example of a second embodiment of the smartphone of the present disclosure.

FIG. 8 is a flowchart describing drop notification processing according to the second embodiment of the present disclosure.

FIG. 9 is a diagram describing a configuration example of a third embodiment of the smartphone of the present disclosure.

FIG. 10 is a diagram describing a configuration example of the third embodiment of the earphone of the present disclosure.

FIG. 11 is a flowchart describing drop notification processing according to the third embodiment of the present disclosure.

FIG. 12 is a diagram describing a packet format of LE Coded Phy.

FIG. 13 is a diagram describing a configuration example of a fourth embodiment of the earphone of the present disclosure.

FIG. 14 is a flowchart describing drop notification processing according to the fourth embodiment of the present disclosure.

FIG. 15 is a diagram describing an LE set Extended Advertising Parameters command.

FIG. 16 is a diagram describing a configuration example of a fifth embodiment of the earphone of the present disclosure.

FIG. 17 is a flowchart describing drop notification processing according to the fifth embodiment of the present disclosure.

FIG. 18 is a diagram describing a configuration example of a general-purpose computer.

### MODE FOR CARRYING OUT THE INVENTION

Hereinafter, preferred embodiments of the present disclosure will be described in detail with reference to the accompanying drawings. Note that in the description and the drawings, components having substantially the same functional configuration are denoted by the same reference numerals, and redundant descriptions are omitted.

Hereinafter, modes for carrying out the present technology will be described. The description will be made in the following order.
1. Overview of present disclosure
2. First Embodiment
3. Second Embodiment
4. Third Embodiment
5. Fourth Embodiment
6. Fifth Embodiment
7. Example executed by software

### 1. Overview of Present Disclosure

The present disclosure enables recognition of a drop by communication from a dropped communication device, and enables specification of the position of the dropped communication device.

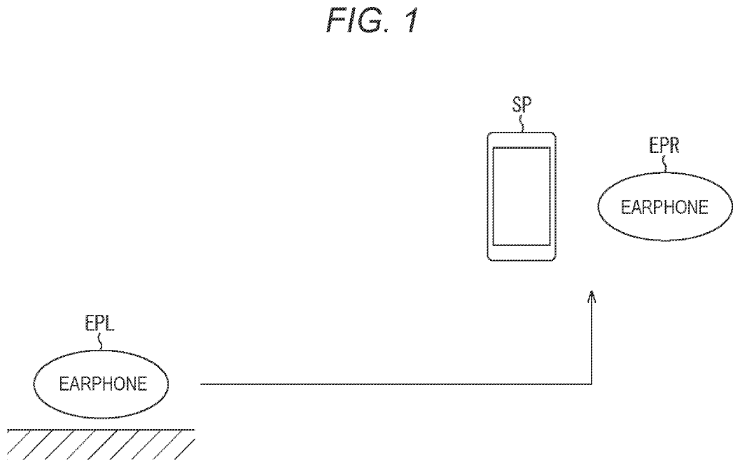

The technology of the present disclosure is implemented by, for example, a communication system including a smartphone SP as illustrated in FIG. 1 and earphones EPL and EPR (left ear earphone EPL and right ear earphone EPR) worn on the left and right ears.

Here, the smartphone SP reproduces the content and transmits the sound of reproduced content to the earphones EPL and EPR by, for example, short-range communication such as Bluetooth (registered trademark) communication. The earphones EPL and EPR receive audio data of the content reproduced and transmitted in the smartphone SP by short-range communication, and output the audio data as sound.

Each of the earphones EPL and EPR in FIG. 1 includes a proximity sensor, an acceleration sensor, and the like, and is capable of recognizing dropping from the ear, for example.

For example, as illustrated in the left part of FIG. 1, in a case where the left ear earphone EPL drops, the earphone EPL itself detects the drop and notifies the smartphone SP or the right ear earphone EPR that has not dropped that the drop is detected. Furthermore, the earphone EPL performs smartphone SP communication of a drop position notification signal for specifying its own position.

Through this processing, the smartphone SP notifies that the drop has occurred on the basis of the communication from the left ear earphone EPL, and specifies the position of the left ear earphone EPL and displays it as an image.

Furthermore, the right ear earphone EPR outputs sound notifying that the drop of the left ear earphone EPL is detected.

With such processing, the user carrying the smartphone SP and wearing the right ear earphone EPR can recognize the drop of the left ear earphone EPL and specify the position of the dropping left ear earphone.

Consequently, it is possible to recognize the drop of the left ear earphone and specify the position where the left ear earphone has dropped.

### 2. First Embodiment

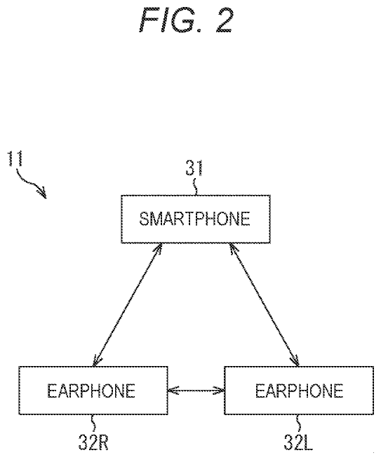

Next, a configuration example of a first embodiment of the communication system of the present disclosure will be described with reference to FIG. 2.

The communication system 11 in FIG. 2 includes a smartphone 31 and earphones 32L and 32R carried by the same user.

The smartphone 31 is a mobile terminal, and can make a call or perform data communication with another smartphone via a public wireless communication line, and can reproduce content including an image and sound received by the data communication.

The smartphone 31 and the earphones 32L and 32R are capable of performing short-range communication such as Bluetooth (registered trademark) communication, and transmit sound of content reproduced by the smartphone 31 to the earphone 31L for the left ear and the earphone 31R for the right ear so that the sound is output.

The earphones 32L and 32R are in a paired configuration with each other, are worn on the left ear and the right ear of the user, respectively, receive audio data transmitted from the smartphone 31 via the short-range communication such as Bluetooth (registered trademark) communication, and output the audio data as monaural sound or stereo sound.

Each of the earphones 32L and 32R includes a sensor that detects a drop, and when detecting the drop, transmits a notification indicating that the drop is detected to the smartphone 31.

When the notification indicating that the drop has been detected in at least one of the earphones 32L and 32R is transmitted, the smartphone 31 displays the notification as an image on a display unit including an organic EL (Electronic Luminescence), an LCD (Liquid Crystal Display), or the like to notify the user that the drop of the earphones 32L and 32R has been detected.

When the notification indicating that the drop has been detected in at least one of the earphones 32L and 32R is transmitted, the smartphone 31 transmits the notification indicating that the drop has been detected in the earphone 32L or 32R to one of the earphones 32L and 32R in which the drop has not been detected, and causes the earphone to notify the user of the detection of the drop by sound.

Furthermore, when detecting the drop, the earphones 32L and 32R transmit the drop position notification signal for specifying their own positions to the smartphone 31.

When the drop position notification signal is transmitted from at least one of the earphones 32L and 32R in which the drop has been detected, the smartphone 31 specifies (estimates) a direction of the earphones 32L and 32R in which the drop has been detected on the basis of, for example, Bluetooth Low Energy (BLE) Angle of Arrival (AoA).

Alternatively, when the drop position notification signal is transmitted from at least one of the earphones 32L and 32R in which the drop has been detected, the smartphone 31 specifies (estimates) a direction and a distance (position of earphones 32L and 32R) of the earphones 32L and 32R in which the drop has been detected on the basis of, for example, BLE AoD (Angle of Departure).

Then, the smartphone 31 displays a direction or a direction and a distance of the earphones 32L and 32R in which the specified (estimated) drop is detected on the display unit.

Note that, hereinafter, in a case where it is not necessary to particularly distinguish the earphones 32L and 32R, the earphones are simply referred to as an earphone 32, and other configurations are also referred to in a similar manner.

<Configuration Example of Smartphone>

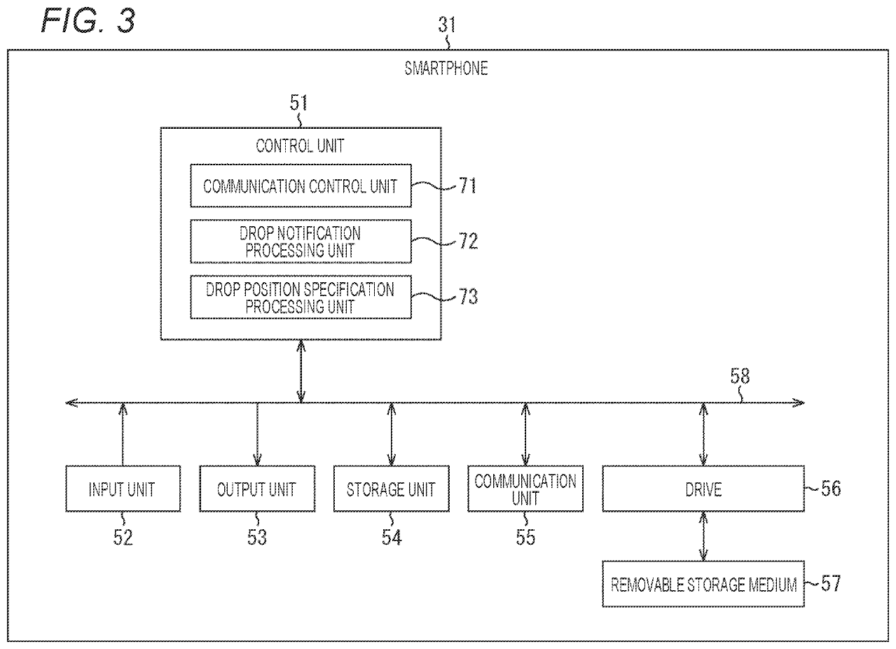

Next, a configuration example of the smartphone 31 will be described with reference to FIG. 3.

The smartphone 31 includes a control unit 51, an input unit 52, an output unit 53, a storage unit 54, a communication unit 55, a drive 56, and a removable storage medium 57, and is connected to each other via a bus 58, and can transmit and receive data and programs.

The control unit 51 includes a processor and a memory, and controls the entire operation of the smartphone 31. Furthermore, the control unit 51 includes a communication control unit 71, a drop notification processing unit 72, and a drop position specification processing unit 73.

The communication control unit 71 controls the communication unit 55 to execute communication processing with another communication device. The communication control unit 71 implements, for example, pairing processing for implementing Bluetooth (registered trademark) communication with the earphones 32L and 32R, and implements communication with the paired earphones 32L and 32R. Furthermore, the control unit 51 reproduces content and controls the communication control unit 71 to transmit audio data of the reproduced content to the earphones 32L and 32R.

The drop notification processing unit 72 controls the communication unit 55 to determine whether or not the earphones 32L and 32R have dropped according to whether or not information notifying that a drop event indicating an occurrence of a drop in any of the earphones 32L and 32R has been detected is transmitted in communication with the earphones 32L and 32R paired by the communication control unit 71.

In a case where the drop of at least one of the earphones 32L and 32R is detected, the drop notification processing unit 72 causes a display constituting the output unit 53 to display information indicating that the drop is detected, or causes a vibrator constituting the output unit 53 to vibrate to notify that the drop of the earphones 32L and 32R is detected.

The drop position specification processing unit 73 specifies (estimates) the directions of the earphones 32L and 32R dropped by Bluetooth Low Energy (BLE) Angle of Arrival (AoA) using the drop position notification signal transmitted from the earphones 32L and 32R whose drop is detected by the drop notification processing unit 72.

Alternatively, the drop position specification processing unit 73 specifies (estimates) the positions of the earphones 32L and 32R dropped by BLE AoD (Angle of Departure) using the drop position notification signal transmitted from the earphones 32L and 32R whose drop is detected by the drop notification processing unit 72.

When the direction or the position of the earphones 32L and 32R that are dropped is specified, the drop position specification processing unit 73 outputs the direction or the position to the drop notification processing unit 72. In response to this, the drop notification processing unit 72 presents information regarding the direction or position of the earphones 32L and 32R dropped on the display of the output unit 53.

The input unit 52 includes an input device such as an operation button or a touch panel with which the user inputs an operation command, and supplies various input signals to the control unit 51.

The output unit 53 is controlled by the control unit 51, and includes a display unit (a display device (including a touch panel)) including a liquid crystal display (LCD), an organic electro luminescence (EL), or the like, and a vibrator that vibrates or the like for the supplied operation screen and image of the processing result, and presents various types of information by the image and the vibration. Note that the output unit 53 may have a configuration other than the display unit and the vibrator as long as various types of information can be presented, and may be, for example, a speaker, a light emitting unit, or the like.

The storage unit 54 includes a hard disk drive (HDD), a solid state drive (SSD), a semiconductor memory, or the like, is controlled by the control unit 51, and writes or reads various data and programs.

The communication unit 55 is controlled by the control unit 51, and transmits and receives various data and programs to and from various devices including the earphone 32 by a local area network (LAN), Bluetooth (registered trademark), or the like.

The drive 56 reads and writes data from and to the removable storage medium 57 such as a magnetic disk (including a flexible disk), an optical disk (including a compact disc-read only memory (CD-ROM) and a digital versatile disc (DVD)), a magneto-optical disk (including a Mini Disc (MD)), or a semiconductor memory.

<Configuration Example of Earphone>

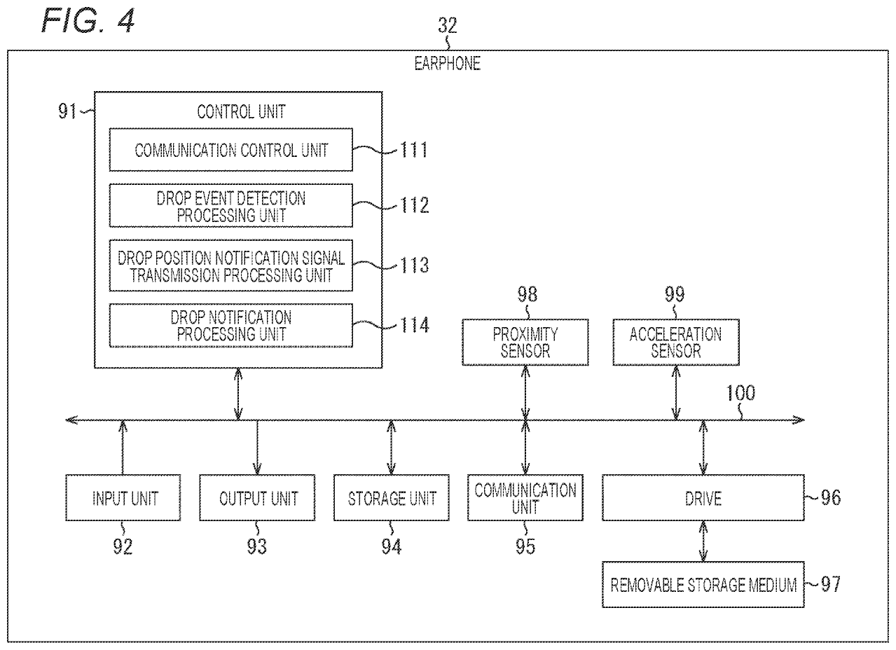

Next, a configuration example of the earphone 32 will be described with reference to FIG. 4.

The earphone 32 includes a control unit 91, an input unit 92, an output unit 93, a storage unit 94, a communication unit 95, a drive 96, a removable storage medium 97, a proximity sensor 98, and an acceleration sensor 99, and is connected to each other via a bus 100, and can transmit and receive data and programs.

The control unit 91 includes a processor and a memory, and controls the entire operation of the earphone 32. Furthermore, the control unit 91 includes a communication control unit 111, a drop event detection processing unit 112, a drop position notification signal transmission processing unit 113, and a drop notification processing unit 114.

The communication control unit 111 controls the communication unit 115 to execute communication processing with another communication device. The communication control unit 111 implements, for example, the pairing processing for implementing Bluetooth (registered trademark) communication with the smartphone 31, and implements communication with the paired smartphone 31. The control unit 91 controls the communication control unit 111 to receive audio data transmitted from the smartphone 31 and output the audio data as sound from the speaker constituting the output unit 93.

The drop event detection processing unit 112 detects the presence or absence of a drop event indicating that the earphone 32 has dropped on the basis of detection results of the proximity sensor 98 and the acceleration sensor 99.

The drop event detection processing unit 112 detects the presence or absence of occurrence of the drop event indicating that the earphone 32 has dropped from a pattern of a sensing result of the proximity sensor 98, and a time-series detection pattern of acceleration detected by the acceleration sensor 99.

The drop event detection processing unit 112 may be implemented by a deep neural network (DNN). In a case where the earphone 32 is provided with, for example, an audio analysis engine implemented by the DNN, the function of the drop event detection processing unit 112 may be implemented using the DNN used in the audio analysis engine to detect the drop event.

After the drop event is detected by the drop event detection processing unit 112 and the notification indicating that the drop event has been detected is transmitted to the smartphone 31, the drop position notification signal transmission processing unit 113 transmits the drop position notification signal for specifying the direction and position of the earphone 32 to the smartphone 31 by Bluetooth low energy (BLE) communication.

When the notification indicating that the drop event of the other earphone 32 has been detected is transmitted from the smartphone 31, the drop notification processing unit 114 outputs sound indicating that the drop event of one earphone 32 is detected from the speaker constituting the output unit 93.

That is, in a case where the drop event indicating dropping is detected by the drop event detection processing unit 112 in the other earphone 32 of the left and right earphones 32, the smartphone 31 transmits a notification indicating that the drop event of the other earphone 32 has been detected to the one earphone 32 in which the drop event has not been detected.

Accordingly, in response to this notification, the drop notification processing unit 114 outputs sound indicating that a drop event of the other earphone 32 is detected as sound from the speaker constituting the output unit 93.

The input unit 92 includes an input device such as an operation button for the user to input an operation command, and supplies various input signals to the control unit 91.

The output unit 93 is a speaker that is controlled by the control unit 91 and outputs sound.

The storage unit 94 includes a hard disk drive (HDD), a solid state drive (SSD), a semiconductor memory, or the like, is controlled by the control unit 91, and writes or reads various data and programs.

The communication unit 95 is controlled by the control unit 91, and transmits and receives various data and programs to and from the smartphone 31 by Bluetooth (registered trademark) communication.

The drive 96 reads and writes data from and to a removable storage medium 97 such as a magnetic disk (including a flexible disk), an optical disk (including a compact disc-read only memory (CD-ROM) and a digital versatile disc (DVD)), a magneto-optical disk (including a mini disc (MD)), or a semiconductor memory.

The proximity sensor 98 is an electromagnetic induction type, a magnetic type, an electrostatic type, or the like, detects whether or not the earphone 32 is in a state of being in close contact with the human body, that is, in a state of being worn on the ear, and outputs the detection result to the control unit 91.

The acceleration sensor 99 is, for example, a micro electro mechanical systems (MEMS) type acceleration sensor, and detects acceleration of the earphone 32 and outputs the acceleration to the control unit 91.

<Drop Notification Processing>

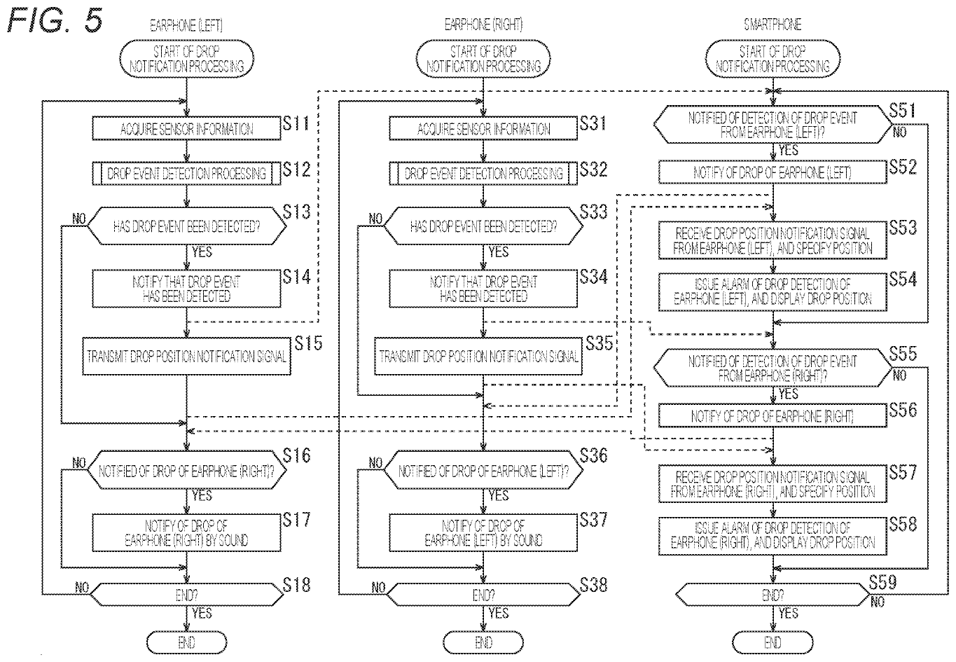

Next, drop notification processing by the communication system 11 of FIG. 2 will be described with reference to a flowchart of FIG. 5. Note that, in the following description of processing, it is assumed that Bluetooth (registered trademark) communication (BLE communication) is established by pairing in advance through communication between the communication control unit 71 of the smartphone 31 and the communication control units 111 of the earphones 32L and 32R, and it is a state that communication can be performed with each other.

In step S11, the drop event detection processing unit 112 of the earphone 32L acquires, as sensor information, a detection result indicating whether or not the earphone 32L detected by the proximity sensor 98 is away from the user's ear, and a detection result including the acceleration of the earphone 32L by the acceleration sensor 99.

In step S12, the drop event detection processing unit 112 of the earphone 32L executes drop event detection processing of the earphone 32L on the basis of the acquired sensor information, and detects the presence or absence of a drop event.

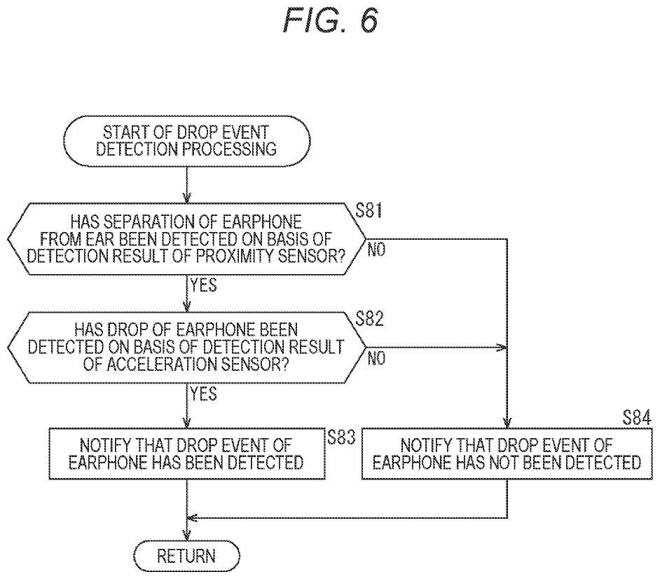

Note that details of the drop event detection processing will be described later with reference to the flowchart of FIG. 6.

In step S13, the drop event detection processing unit 112 of the earphone 32L determines whether or not a drop event of the earphone 32L has been detected on the basis of a processing result of the drop event detection processing.

In a case where it is determined in step S13 that the drop event of the earphone 32L has been detected, that is, in a case where it is regarded that the earphone 32L has fallen out and dropped from the ear, the processing proceeds to step S14.

In step S14, the drop event detection processing unit 112 of the earphone 32L controls the communication unit 95 to notify the smartphone 31 that the drop event of the earphone 32L has been detected.

At this time, in the smartphone 31, in step S51, the drop notification processing unit 72 controls the communication unit 55 to determine whether or not a notification indicating that a drop event has been detected has been transmitted from the earphone 32L.

In a case where it is determined in step S51 that the notification indicating that a drop event has been detected has been transmitted from the earphone 32L, the processing proceeds to step S52.

In step S52, the drop notification processing unit 72 controls the communication unit 55 to receive the notification indicating that a drop event has been detected, which has been transmitted from the earphone 32L, and notify the earphone 32R that the drop event has been detected in the earphone 32L.

Furthermore, in the earphone 32R, in step S36, the drop notification processing unit 114 controls the communication unit 95 to determine whether or not a notification indicating that a drop event has been detected in the earphone 32L has been transmitted from the smartphone 31.

In a case where it is determined in step S36 that the notification indicating that a drop event has been detected in the earphone 32L has been transmitted from the smartphone 31, the processing proceeds to step S37.

In step S37, the drop notification processing unit 114 notifies by sound that a drop event has been detected in the earphone 32L. The sound output here may be beep sound, buzzer sound, or announcement voice such as “the earphone of the left ear has dropped”.

By the processing so far, when a drop event is detected in the earphone 32L, the smartphone 31 is notified of the detection of the drop event, the earphone 32R is notified of the detection of the drop event from the smartphone 31, and the user is notified of the detection of the drop event in the earphone 32L by sound.

Thus, when the earphone 32L worn on the left ear of the user drops, the earphone 32R worn on the right ear is notified via the smartphone 31, and the user is notified by sound.

By the notification by sound of the worn earphone 32R of the right ear, the user can recognize that the drop event has been detected in the earphone 32L that has been worn on the left ear in which the drop event is detected.

Furthermore, in the earphone 32L, in step S15, the drop position notification signal transmission processing unit 113 controls the communication unit 95 to start transmission of the drop position notification signal to the smartphone 31 by BLE communication.

Note that in a case where it is determined in step S13 that no drop event has been detected, the processing in steps S14 and S15 is skipped.

Here, in the smartphone 31, in step S53, the drop position specification processing unit 73 controls the communication unit 55 to receive the drop position notification signal transmitted from the earphone 32L.

Then, on the basis of the received drop position notification signal, the drop position specification processing unit 73 specifies the direction and position of the earphone 32L by Bluetooth Low Energy (BLE) Angle of Arrival (AoA) or BLE Angle of Departure (AoD), and outputs the direction and position to the drop notification processing unit 72.

In step S54, the drop notification processing unit 72 controls the vibrator constituting the output unit 53 to generate vibration to issue an alarm, and notify the user that the earphone 32L has dropped.

At the same time, the drop notification processing unit 72 causes the display constituting the output unit 53 to display the information regarding the direction and position of the earphone 32L on the basis of the information regarding the specified direction and position of the earphone 32L.

With this processing, the user carrying the smartphone 31 can recognize that the earphone 32L has dropped due to vibration of the vibrator of the smartphone 31. Furthermore, the user carrying the smartphone 31 can quickly find the dropped earphone 32L since the information regarding the direction and position of the dropped earphone 32L is displayed on the display constituting the output unit 53 of the smartphone 31.

Note that in a case where it is determined in step S51 that the notification indicating that a drop event has been detected has not been transmitted from the earphone 32L, the processing of steps S52 to S54 is skipped.

In the above description, the processing in a case where the earphone 32L worn on the left ear drops has been described, but basically, similar processing is performed in a case where the earphone 32R worn on the right ear drops.

That is, in step S31, the drop event detection processing unit 112 of the earphone 32R acquires, as the sensor information, a detection result indicating whether or not the earphone 32R detected by the proximity sensor 98 is away from the user's ear, and a detection result including the acceleration of the earphone 32R by the acceleration sensor 99.

In step S32, the drop event detection processing unit 112 of the earphone 32R executes the drop event detection processing on the basis of the acquired sensor information, and detects the presence or absence of a drop event of the earphone 32R.

In step S33, the drop event detection processing unit 112 of the earphone 32R determines whether or not a drop event of the earphone 32R has been detected.

In a case where it is determined in step S33 that the drop event of the earphone 32R has been detected, that is, in a case where it is regarded that the earphone 32R has fallen out and dropped from the ear, the processing proceeds to step S34.

In step S34, the drop event detection processing unit 112 of the earphone 32R controls the communication unit 95 to notify the smartphone 31 that the drop event of the earphone 32R has been detected by the BLE communication.

At this time, in the smartphone 31, in step S55, the drop notification processing unit 72 controls the communication unit 55 to determine whether or not a notification indicating that a drop event has been detected has been transmitted from the earphone 32R.

In a case where it is determined in step S55 that the notification indicating that a drop event has been detected has been transmitted from the earphone 32R, the processing proceeds to step S56.

In step S56, the drop notification processing unit 72 controls the communication unit 55 to receive the notification indicating that a drop event has been detected, which has been transmitted from the earphone 32R, and notify the earphone 32L that the drop event has been detected in the earphone 32R.

Furthermore, in the earphone 32L, in step S16, the drop notification processing unit 114 controls the communication unit 95 to determine whether or not a notification indicating that a drop event has been detected in the earphone 32R has been transmitted from the smartphone 31.

In a case where it is determined in step S16 that the notification indicating that a drop event has been detected in the earphone 32R has been transmitted from the smartphone 31, the processing proceeds to step S17.

In step S17, the drop notification processing unit 114 notifies by sound that a drop event has been detected in the earphone 32R.

By the processing so far, when a drop event is detected in the earphone 32R, the smartphone 31 is notified of the detection of the drop event, the earphone 32L is notified of the detection of the drop event from the smartphone 31, and the user is notified of the detection of the drop event in the earphone 32R by sound.

Thus, when the earphone 32R worn on the right ear of the user drops, the earphone 32L worn on the left ear is notified via the smartphone 31, and the user is notified by sound.

By the notification by sound of the worn earphone 32L of the left ear, the user can recognize that the drop event has been detected in the earphone 32R that has been worn on the right ear in which the drop event has been detected.

Furthermore, in the earphone 32R, in step S35, the drop position notification signal transmission processing unit 113 controls the communication unit 95 to start transmission of the drop position notification signal to the smartphone 31 by the BLE communication.

Note that in a case where it is determined in step S33 that no drop event has been detected, the processing in steps S34 and S35 is skipped.

Here, in the smartphone 31, in step S57, the drop position specification processing unit 73 controls the communication unit 55 to receive the drop position notification signal transmitted from the earphone 32R.

Then, on the basis of the received drop position notification signal, the drop position specification processing unit 73 specifies the direction and position of the earphone 32R by Bluetooth Low Energy (BLE) Angle of Arrival (AoA) or BLE Angle of Departure (AoD), and outputs the direction and position to the drop notification processing unit 72.

In step S58, the drop notification processing unit 72 controls the vibrator constituting the output unit 53 to generate vibration to issue an alarm, and notify the user that the earphone 32R has dropped.

At the same time, the drop notification processing unit 72 causes the display constituting the output unit 53 to display the information regarding the direction and position of the earphone 32R on the basis of the information regarding the specified direction and position of the earphone 32R.

With this processing, the user carrying the smartphone 31 can recognize that the earphone 32R has dropped due to vibration of the vibrator of the smartphone 31. Furthermore, the user carrying the smartphone 31 can quickly find the dropped earphone 32R since the information regarding the direction and position of the dropped earphone 32R is displayed on the display constituting the output unit 53 of the smartphone 31.

Note that, in a case where it is determined in step S55 that the notification indicating that a drop event has been detected has not been transmitted from the earphone 32R, the processing of steps S56 to S58 is skipped.

Furthermore, in steps S18, S38, and S59, it is determined whether or not an instruction to end the processing has been given, and in a case where the instruction to end the processing has not been given, the processing returns to the processing of S11, S31, and S51, respectively, and the subsequent processing is repeated.

Then, in a case where it is determined in steps S18, S38, and S59 that the instruction to end the processing has been given, the processing ends.

Through the above series of processing, when a drop event is detected in any of the left and right earphones 32 (32L and 32R), the smartphone 31 is notified of the drop event from the earphone 32 in which the drop event has been detected, and the earphone 32 in which the drop event has not been detected is notified of the detection of the drop event.

The earphone 32 notified of the detection of the drop event notifies the user of the detection of the drop event in the left-right inverted earphone 32 by sound.

The earphone 32 in which the drop event has been detected continues to transmit the drop position notification signal to the smartphone 31. Upon receiving the drop position notification signal, the smartphone 31 specifies the direction and position of the earphone 32 in which the drop event has been detected by the AoD or the AoA on the basis of the drop position notification signal.

Then, the smartphone 31 vibrates the vibrator constituting the output unit 53 to notify the user that the drop event has been detected by any of the earphones 32.

At the same time, the smartphone 31 displays the direction and position of the earphone 32 in which the specified drop event has been detected on the display constituting the output unit 53.

Consequently, the user can recognize that the drop event has been detected in the earphone 32 by the notification of the sound from the earphone 32 in which the drop event has not been detected and the vibration of the vibrator of the smartphone 31.

Furthermore, since the position of the earphone 32 in which the drop event has been detected, which is specified on the basis of the drop position notification signal, is displayed, the user can quickly find the earphone 32 in which the drop event has been detected.

<Drop Event Detection Processing>

Next, the drop event detection processing will be described with reference to the flowchart of FIG. 6.

In step S81, the drop event detection processing unit 112 determines whether or not the earphone 32 is away from the user's ear on the basis of the detection result of the proximity sensor 98.

In a case where it is determined in step S81 that the earphone 32 is away from the user's ear, the processing proceeds to step S82.

In step S82, the drop event detection processing unit 112 determines whether or not the earphone 32 has dropped on the basis of the detection result of the acceleration sensor 99. More specifically, the drop event detection processing unit 112 determines whether or not the earphone 32 has dropped on the basis of whether or not a change is obtained such that, after time-series acceleration that is the detection result of the acceleration sensor 99, for example, acceleration according to gravitational acceleration is obtained, and after the earphone drops by about the height of a human, the earphone suddenly stops.

In step S82, in a case where the drop of the earphone 32 is detected, the processing proceeds to step S83.

In step S83, the drop event detection processing unit 112 considers that a drop event of the earphone 32 has been detected, and the processing ends.

Furthermore, in a case where it is determined in step S81 that the earphone 32 is not away from the user's ear, or in a case where it is determined in step S82 that the drop of the earphone 32 has not been detected, the processing proceeds to step S84.

In step S84, the drop event detection processing unit 112 determines that no drop event of the earphone 32 has been detected, and the processing ends.

By the above processing, in a case where it is regarded that the earphone 32 is separated from the ear according to the detection result of the proximity sensor 98, and it is regarded that the drop of the earphone 32 is detected according to the detection result of the acceleration sensor 99, it is regarded that the drop event of the earphone 32 has been detected.

Note that the drop event detection processing in FIG. 6 is an example, and other processing may be performed. For example, the drop event of the earphone 32 may be regarded as being detected in only one of a case where it is regarded that the earphone 32 is separated from the ear according to the detection result of the proximity sensor 98 and a case where it is regarded that the drop of the earphone 32 is detected according to the detection result of the acceleration sensor 99.

Furthermore, the sensor used for the drop event detection may be a sensor other than the proximity sensor 98 and the acceleration sensor 99. For example, an impact detection sensor may be provided so that a drop event is detected in a case where an impact is detected. Furthermore, for example, an image sensor or a brightness/darkness sensor that images the inside of the ear may be provided, and when a black image is captured, it may be regarded as being worn on the ear, and when a bright image is captured, it may be recognized that the user is away from the ear and a drop event may be detected.

Note that, although the example in which the communication system 11 includes the smartphone 31 and the earphones 32L and 32R has been described above, the communication system is only required to be capable of short-range communication such as Bluetooth (registered trademark) communication, and thus may be implemented by other communication devices.

For example, instead of the earphone 32, the communication system may include a hearing aid, a wearable terminal, or the like. Furthermore, a communication system may include a personal computer or the like instead of the smartphone 31.

### 3. Second Embodiment

In the above, although the processing in a case where one of the left and right earphones 32L and 32R is worn on the ear without dropping has been described, in a case where both the left and right earphones 32L and 32R drop, detection of a drop event of the earphone 32 may be presented by vibration and display on the smartphone 31 without notification of detection of the drop event from the smartphone 31 to the earphone 32.

<Configuration Example of Smartphone in Second Embodiment>

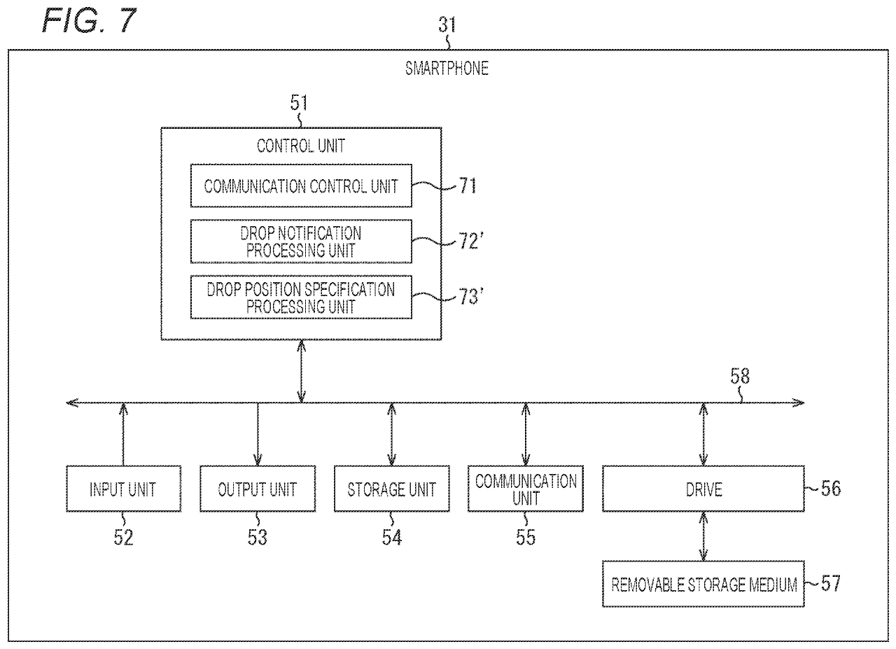

FIG. 7 illustrates a configuration example of the smartphone 31 in which, in a case where both the left and right earphones 32L and 32R drop, detection of a drop event of the earphone 32 is presented by vibration and display on the smartphone 31 without providing a notification of detection of the drop event from the smartphone 31 to the earphone 32.

In the smartphone 31 in FIG. 7, components having the same functions as those of the smartphone 31 in FIG. 3 are denoted by the same reference numerals, and the description thereof will be omitted as appropriate.

The smartphone 31 in FIG. 7 is different from the smartphone 31 in FIG. 3 in that a drop notification processing unit 72′ and a drop position specification processing unit 73′ are provided instead of the drop notification processing unit 72 and the drop position specification processing unit 73.

The drop notification processing unit 72′ is similar in basic function to the drop notification processing unit 72, but determines whether or not the other drop event has been detected within a predetermined time from a timing at which the drop event has been detected from one of the earphones 32L and 32R.

That is, the drop notification processing unit 72′ determines whether or not the earphones 32L and 32R have dropped simultaneously.

In a case where the drop notification processing unit 72′ determines that the earphones 32L and 32R have dropped simultaneously, the drop position specification processing unit 73′ receives the drop position notification signals transmitted from both the earphones 32L and 32R, and specifies the directions and positions of both the earphones 32L and 32R.

The drop notification processing unit 72′ causes the vibrator of the output unit 53 to vibrate to notify the user carrying the smartphone 31 of the drop of the earphones 32L and 32R, and causes the display unit to display an image indicating the directions and positions of the earphones 32L and 32R.

Note that the configurations of the earphones 32L and 32R are similar to the configuration of FIG. 4, and thus the description thereof will be omitted.

<Dropping Notification Processing in Case of Using Smartphone of FIG. 7>

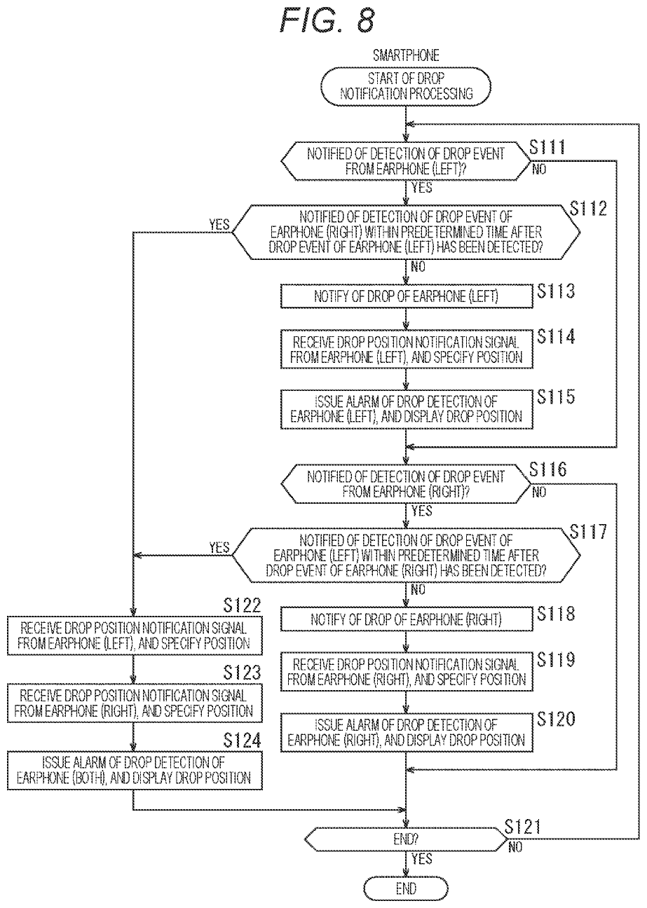

Next, with reference to the flowchart of FIG. 8, drop notification processing in a case of using the smartphone of FIG. 7 will be described.

Note that the processing of steps S111, S113 to S116, and S118 to S121 in the flowchart of FIG. 8 is similar to the processing of steps S51 to S59 in the flowchart of FIG. 5, and thus the description thereof will be omitted. In addition, the processing of the earphones 32L and 32R is the same as the flowchart of FIG. 5, and thus the description thereof will be omitted.

That is, in a case where it is determined in step S111 that a notification indicating that a drop event has been detected has been transmitted from the earphone 32L, the processing proceeds to step S112.

In step S112, the drop notification processing unit 72′ controls the communication unit 55 to determine whether or not the notification indicating that a drop event has been detected has been transmitted from the earphone 32R within the predetermined time after the notification indicating that a drop event has been detected has been transmitted from the earphone 32L.

That is, it is determined whether or not the earphone 32R has dropped within the predetermined time after the earphone 32L has dropped, that is, at substantially the same timing, and both the earphones 32L and 32R have dropped.

In a case where it is determined in step S112 that the notification indicating that a drop event has been detected has been transmitted from the earphone 32R within the predetermined time after the notification indicating that a drop event has been detected has been transmitted from the earphone 32L, the processing proceeds to step S122.

Note that, in a case where it is determined in step S112 that the notification indicating that a drop event has been detected has not been transmitted from the earphone 32R within the predetermined time after the notification indicating that a drop event has been detected has been transmitted from the earphone 32L, the processing proceeds to step S113.

Furthermore, in a case where it is determined in step S116 that the notification indicating that a drop event has been detected has been transmitted from the earphone 32R, the processing proceeds to step S117.

In step S117, the drop notification processing unit 72′ controls the communication unit 55 to determine whether or not the notification indicating that a drop event has been detected has been transmitted from the earphone 32L within the predetermined time after the notification indicating that a drop event has been detected has been transmitted from the earphone 32R.

That is, it is determined whether or not the earphone 32L has dropped within the predetermined time after the earphone 32R has dropped, that is, at substantially the same timing, and both the earphones 32L and 32R have dropped.

In a case where it is determined in step S117 that the notification indicating that a drop event has been detected has been transmitted from the earphone 32L within the predetermined time after the notification indicating that a drop event has been detected has been transmitted from the earphone 32R, the processing proceeds to step S122.

Note that in a case where it is determined in step S117 that the notification indicating that a drop event has been detected has not been transmitted from the earphone 32L within the predetermined time after the notification indicating that a drop event has been detected has been transmitted from the earphone 32R, the processing proceeds to step S118.

That is, in a case where it is determined in both steps S112 and S117 that both the earphones 32L and 32R have dropped, the processing proceeds to step S122.

In step S122, the drop position specification processing unit 73′ controls the communication unit 55 to receive the drop position notification signal transmitted from the earphone 32L, specifies the direction and position of the earphone 32L, and outputs the signal to the drop notification processing unit 72′.

In step S123, the drop position specification processing unit 73′ controls the communication unit 55 to receive the drop position notification signal transmitted from the earphone 32R, specifies the direction and position of the earphone 32L, and outputs the signal to the drop notification processing unit 72′.

In step S124, the drop notification processing unit 72′ controls the vibrator constituting the output unit 53 to generate vibration to issue an alarm, and notify the user that the earphones 32L and 32R have dropped.

At the same time, the drop notification processing unit 72′ causes the display constituting the output unit 53 to display an image indicating information regarding the directions and positions of the earphones 32L and 32R on the basis of the information regarding the specified directions and positions of the earphones 32L and 32R.

With this processing, the user carrying the smartphone 31 can recognize that earphones 32L and 32R have dropped due to vibration of the vibrator of the smartphone 31.

Furthermore, the user carrying the smartphone 31 can quickly find the dropped earphones 32L and 32R since the images indicating the directions and positions of the dropped earphones 32L and 32R are displayed on the display constituting the output unit 53 of the smartphone 31.

### 4. Third Embodiment

In the above, the example has been described in which the smartphone 31 is notified of a drop event from the earphone 32 in which the drop event has been detected.

However, one earphone 32 in which the drop event has been detected may notify the other earphone 32 that the drop event has been detected.

<Configuration Example of Smartphone in Third Embodiment>

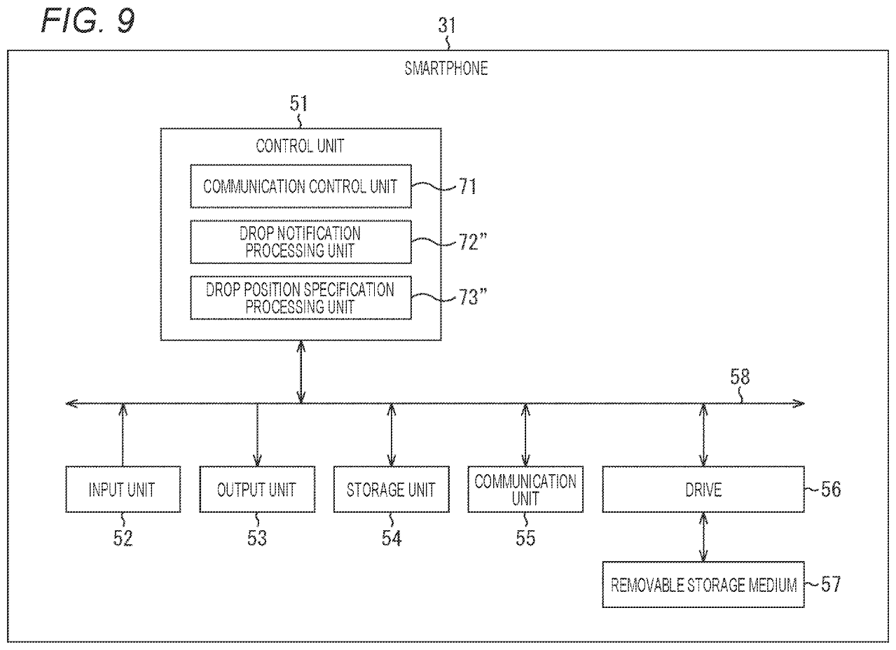

FIG. 9 illustrates a configuration example of the smartphone 31 when a notification of the detection of the drop event is provided from the one earphone 32 in which the drop event has been detected to the other earphone 32.

In the smartphone 31 in FIG. 9, components having the same functions as those of the smartphone 31 in FIG. 3 are denoted by the same reference numerals, and the description thereof will be omitted as appropriate.

The smartphone 31 in FIG. 9 is different from the smartphone 31 in FIG. 3 in that a drop notification processing unit 72″ and a drop position specification processing unit 73″ are provided instead of the drop notification processing unit 72 and the drop position specification processing unit 73.

The drop notification processing unit 72″ has a basic function similar to that of the drop notification processing unit 72, but the drop notification processing unit 72″ in FIG. 9 does not receive the notification indicating that a drop event from the earphone 32 has been detected.

The drop position specification processing unit 73″ has a basic function similar to that of the drop position specification processing unit 73, but is different in that it recognizes that a drop event has occurred with reception of the drop position notification signal as a trigger.

That is, in the third embodiment, information indicating that a drop event has been detected, which is transmitted from the one earphone 32 in which the drop event has been detected, is transmitted to the other earphone 32, and the information indicating that the drop event has been detected is not transmitted to the smartphone 31.

However, since the drop position notification signal from the earphone 32 is transmitted to the smartphone 31, in the third embodiment, the smartphone 31 recognizes that the drop event has been detected on the basis of the presence or absence of the drop position notification signal.

<Configuration Example of Earphone in Third Embodiment>

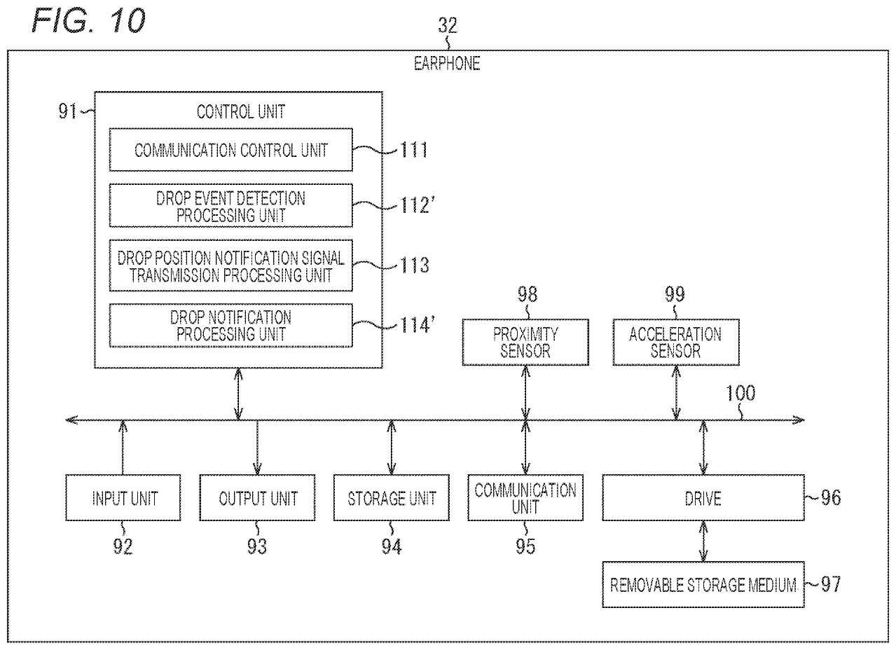

Next, a configuration example of the earphone 32 according to the third embodiment will be described with reference to FIG. 10.

Note that, in the configuration of the earphone 32 in FIG. 10, components having the same functions as those of the earphone 32 in FIG. 4 are denoted by the same reference numerals, and the description thereof will be omitted as appropriate.

The earphone 32 of FIG. 10 is different from the earphone 32 of FIG. 4 in that a drop event detection processing unit 112′ and a drop notification processing unit 114′ are provided instead of the drop event detection processing unit 112 and the drop notification processing unit 114.

The drop event detection processing unit 112′ is similar in basic function to the drop event detection processing unit 112, but is different in that, in a case where a drop event is detected, the drop event detection processing unit notifies the other earphone 32 instead of notifying the smartphone 31.

The drop notification processing unit 114′ is similar in basic function to the drop notification processing unit 114, but is different in that the drop notification processing unit outputs sound notifying of the drop on the basis of the notification from the other earphone 32 instead of outputting sound providing a notification of the drop on the basis of the notification from the smartphone 31.

<Drop Notification Processing in Third Embodiment>

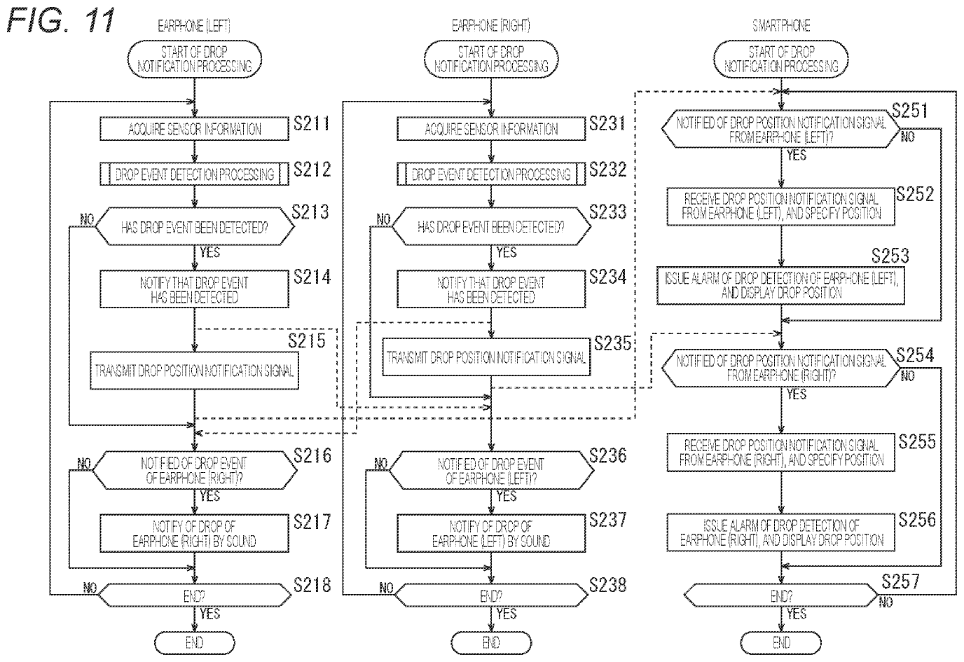

Next, drop notification processing in the third embodiment will be described with reference to FIG. 11.

Note that processing of steps S211 to S213, S215, S217, and S218, processing of steps S231 to S233, S235, S237, and S238, and processing of S252, S253, S255, and S256 in a flowchart of FIG. 11 are similar to the processing of steps S11 to S13, S15, S17, and S18, the processing of S31 to S33, S35, S37, and S38, and the processing of S53, S54, S57, and S58 in the flowchart of FIG. 5, and thus the description thereof is omitted.

That is, when the drop event of the earphone 32L is detected in step S213, the processing proceeds to step S214.

In step S214, the drop event detection processing unit 112′ of the earphone 32L controls the communication unit 95 to notify the earphone 32R that the drop event of the earphone 32L has been detected.

Accordingly, in step S236, the drop notification processing unit 114′ of the earphone 32R controls the communication unit 95 to determine whether or not a notification indicating that a drop event has been detected has been transmitted from the earphone 32L.

In a case where it is determined in step S236 that the notification indicating that a drop event has been detected has been transmitted from the earphone 32L, the processing proceeds to step S237, and a notification of the dropping of the earphone 32L is provided by sound.

Furthermore, in step S233, when a drop event of the earphone 32R is detected, the processing proceeds to step S234.

In step S234, the drop event detection processing unit 112′ of the earphone 32R controls the communication unit 95 to notify the earphone 32L that the drop event of the earphone 32R has been detected.

Accordingly, in step S216, the drop notification processing unit 114′ of the earphone 32L controls the communication unit 95 to determine whether or not a notification indicating that a drop event has been detected has been transmitted from the earphone 32R.

In a case where it is determined in step S216 that the notification indicating that a drop event has been detected has been transmitted from the earphone 32R, the processing proceeds to step S217, and a notification of the dropping of the earphone 32R is provided by sound.

At this time, in the smartphone 31, in step S251, the drop notification processing unit 72″ controls the communication unit 55 to determine whether or not the drop position notification signal has been transmitted from the earphone 32L.

In a case where it is determined in step S251 that the drop position notification signal has been transmitted from the earphone 32L, the processing proceeds to step S252, and the drop position specification processing unit 73″ specifies the direction and position of the earphone 32L on the basis of the drop position notification signal.

Then, in step S253, the drop notification processing unit 72″ causes the vibrator to vibrate to issue an alarm regarding the drop of the earphone 32L and causes display of an image indicating the direction and position of the earphone 32L specified by the drop position specification processing unit 73″.

Furthermore, in step S254, the drop notification processing unit 72″ controls the communication unit 55 to determine whether or not the drop position notification signal has been transmitted from the earphone 32R.

In a case where it is determined in step S254 that the drop position notification signal has been transmitted from the earphone 32R, the processing proceeds to step S255, and the drop position specification processing unit 73″ specifies the direction and position of the earphone 32R on the basis of the drop position notification signal.

Then, in step S256, the drop notification processing unit 72″ causes the vibrator to vibrate to issue an alarm regarding the drop of the earphone 32R, and causes display of an image indicating the direction and position of the earphone 32R specified by the drop position specification processing unit 73″.

By the above processing, when a drop event is detected in one of the left and right earphones 32, the other earphone 32 is directly notified that the drop event is detected, so that it is possible to quickly notify the user of the drop by sound.

Furthermore, also at this time, in the smartphone 31, it is recognized that the drop event has been detected by the drop position notification signal, an alarm regarding the drop of the earphone 32 is issued by vibration, and information regarding the direction and position of the dropping earphone 32 is displayed.

Consequently, the user can recognize the drop of the other earphone 32 by one earphone 32 in the worn state, and can quickly find the dropped earphone 32.

### 5. Fourth Embodiment

In the above, the example has been described in which when a drop event is detected in the earphone 32, the drop position notification signal is transmitted to the smartphone 31, and the direction and position of the dropped earphone 32 are specified.

However, in general, the user who does not notice the drop of the earphone 32 moves away from the dropped earphone 32 as time elapses after the drop, and consequently, the distance between the earphone 32 and the smartphone 31 increases.

For this reason, it is expected that the smartphone 31 becomes difficult to receive the drop position notification signal transmitted from the earphone 32 as the time elapses after the earphone 32 drops, and it becomes difficult to specify the direction and the position.

Accordingly, even if the distance between the earphone 32 and the smartphone 31 becomes long, the drop position notification signal may be transmitted so that the smartphone 31 can receive the drop position notification signal.

For example, by using LE Coded Phy in the Bluetooth (registered trademark) communication standard, instead of decreasing the bit rate by increasing the redundant bits, the error correction capability is increased, so that highly accurate communication can be implemented even in a long distance.

<Packet Format of LE Coded Phy>

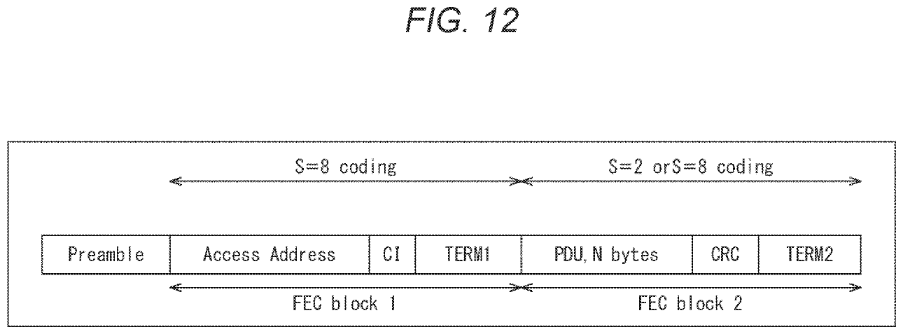

FIG. 12 illustrates an example of a packet format of LE Coded Phy.

The packet format of the LE Coded Phy of FIG. 12 includes a preamble, an FEC block 1, and an FEC block 2.

The preamble is an identifier for recognizing that it is the packet format of LE Coded Phy.

The forward error correction (FEC) block 1 is a block encoded by a scheme (S=8) having the highest redundancy among two types of encryption schemes related to forward error correction.

The FEC block 1 includes an access address (Access Address), a coding indicator (CI), and TERM1.

The access address includes information of an address to be accessed. The CI includes information specifying a scheme used for encoding the FEC block 2. TERM1 is termination information of the FEC block 1.

The FEC block 2 is a block encoded by a scheme (S=2 or S=8) specified by CI of the FEC block 1 among two types of encryption schemes related to forward error correction.

The FEC block 2 includes a PDU (PDU, N bytes), a CRC, and a TERM 2.

A protocol data unit (PDU) is information of a data area. A cyclic redundancy check (CRC) is a region of an error detection code. TERM2 is termination information of the FEC block 2.

That is, in a case where the LE Coded Phy illustrated in FIG. 12 is used, the data length of the PDU of the FEC block 2 is increased to enhance the redundancy of the error correction code, and the CRC is increased to enhance error tolerance as a whole, thereby enhancing communication accuracy in long-distance communication.

The transmission of the drop position notification signal from the earphone 32 can implement long-distance communication by enhancing the error tolerance using LE Coded Phy as illustrated in FIG. 12, for example.

The communication mode in which the error tolerance is increased to enhance the reception accuracy in the long-distance communication using the LE Coded Phy as illustrated in FIG. 12 is hereinafter referred to as a long-distance communication mode.

<Configuration Example of Earphone in Fourth Embodiment>

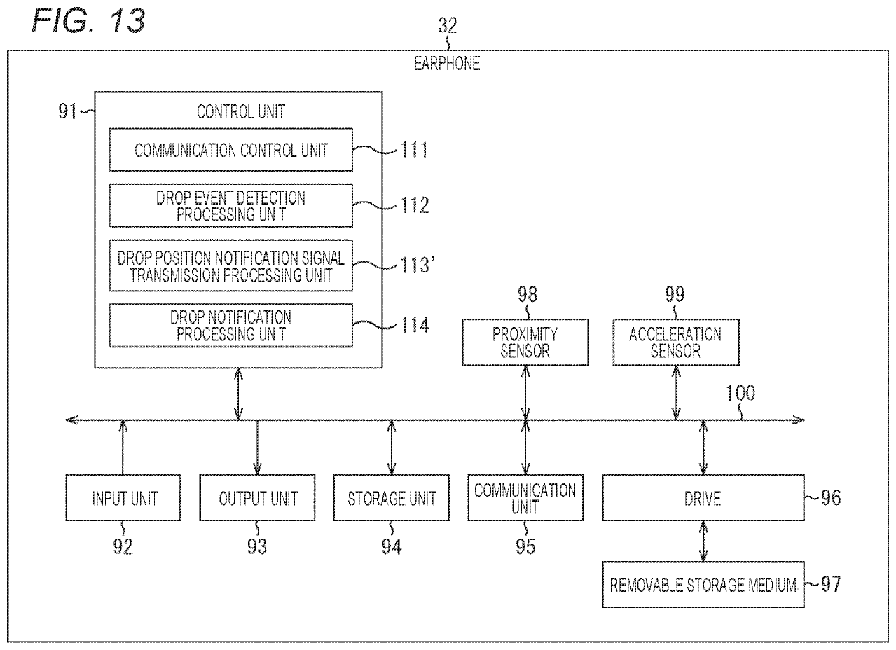

Next, a configuration example of the earphone 32 according to the fourth embodiment will be described with reference to FIG. 13.

In the earphone 32 in FIG. 13, components having the same functions as those of the earphone 32 in FIG. 4 are denoted by the same reference numerals, and the description thereof will be omitted as appropriate.

The earphone 32 of FIG. 13 is different in configuration from the earphone 32 of FIG. 4 in that a drop position notification signal transmission processing unit 113′ is provided instead of the drop position notification signal transmission processing unit 113.

The drop position notification signal transmission processing unit 113′ has the same basic function as the drop position notification signal transmission processing unit 113, but is further different in that the drop position notification signal is transmitted in the long-distance communication mode described above.

That is, by transmitting the drop position notification signal in the long-distance communication mode, the drop position notification signal transmission processing unit 113′ can transmit the drop position notification signal with high accuracy even when the distance between the earphone 32 and the smartphone 31 becomes longer than a predetermined distance.

<Drop Notification Processing in Fourth Embodiment>

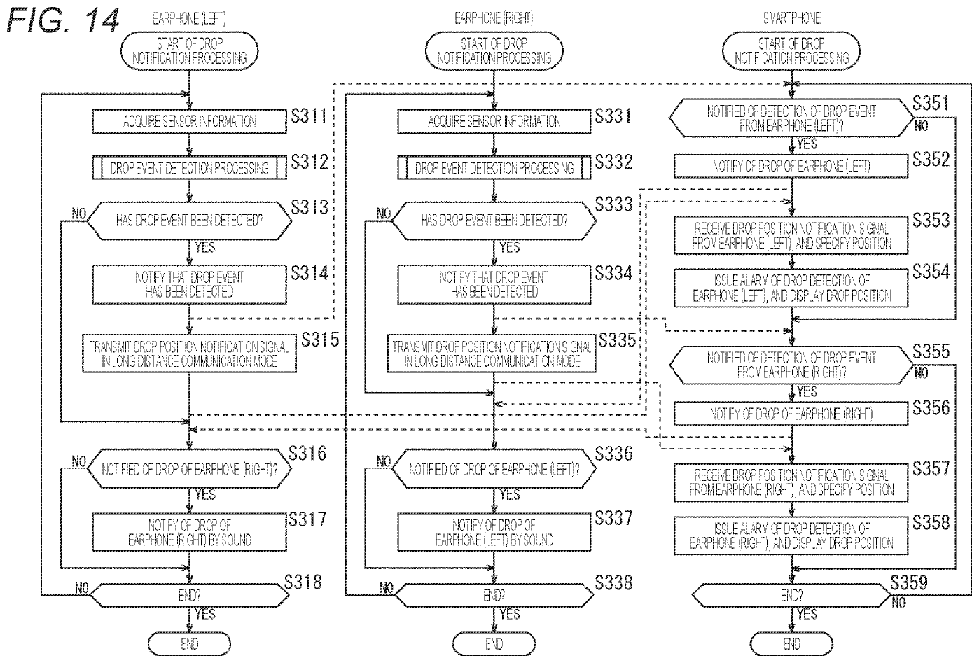

Next, drop notification processing in the fourth embodiment will be described with reference to a flowchart in FIG. 14.

Note that processing of steps S311 to S314 and S316 to S318, processing of steps S331 to S334 and S336 to S338, and processing of steps S351 to S359 in the flowchart of FIG. 14 are similar to the processing of steps S11 to S14 and S16 to S18, the processing of steps S31 to S34 and S36 to S38, and the processing of steps S51 to S59 in the flowchart of FIG. 5, and thus the description thereof is omitted.

That is, in step S315, the drop position notification signal transmission processing unit 113′ of the earphone 32L controls the communication unit 95 to start transmission of the drop position notification signal to the smartphone 31 in the long-distance communication mode using LE Coded Phy in the BLE communication, for example.

Furthermore, in step S335, the drop position notification signal transmission processing unit 113′ of the earphone 32R controls the communication unit 95 to start transmission of the drop position notification signal to the smartphone 31 in the long-distance communication mode using LE Coded Phy in the BLE communication, for example.

With this processing, in the smartphone 31, in each of steps S353 and S357, the drop position specification processing unit 73 controls the communication unit 55 to receive the drop position notification signal transmitted in the long-distance communication mode from the earphone 32L or 32R.

Then, the drop position specification processing unit 73 specifies the direction and position of the earphone 32L by Bluetooth Low Energy (BLE) Angle of Arrival (AoA) or Angle of Departure (BLE AoD) AoD on the basis of the received drop position notification signal.

By the above processing, when the drop event is detected in the earphones 32L and 32R, the drop position notification signal is transmitted to the smartphone 31 in the long-distance communication mode.

Consequently, even if the user carrying the smartphone 31 moves after the earphone 32 drops and the distance becomes longer than the predetermined distance, the drop position notification signal can be transmitted with high accuracy.

Consequently, even if the earphone 32 and the smartphone 31 are away from each other by more than the predetermined distance, the direction and position of the earphone 32 can be specified with high accuracy.

### 6. Fifth Embodiment

In the above, the example has been described in which the direction and position of the earphone 32 can be specified with high accuracy by transmitting the drop position notification signal in the long-distance communication mode even if the earphone 32 and the smartphone 31 are away from each other by more than the predetermined distance.

However, when a predetermined time or more elapses since the earphone 32 has dropped, the distance to the smartphone 31 may be longer than the distance by which the direction or position can be specified, and it is expected that the user carrying the smartphone 31 cannot receive the drop position notification signal unless the distance to the dropped earphone 32 returns to within the predetermined distance.

In this case, when the consumed electric power for transmitting the drop position notification signal is exhausted and the signal can no longer be transmitted, the user carrying the smartphone 31 cannot receive the drop position notification signal even if the user returns to within the predetermined distance from the dropped earphone 32, and thus it is difficult to specify the direction and position of the dropped earphone 32.

Accordingly, the drop position notification signal may be transmitted with a normal transmission output until the predetermined time elapses from the detection of a drop event, and the transmission output of the drop position notification signal may be reduced and transmitted after the predetermined time elapses from the detection of the drop event.

Regarding the reduction of the transmission output, the transmission output itself may be reduced, or the transmission output may be generally reduced by widening the transmission interval.

As described above, by reducing the transmission output of the drop position notification signal, the drop position notification signal can be transmitted for a long time, and even if the elapsed time after the drop becomes long, the direction and position of the earphone 32 can be easily specified, so that it can be easily found.

The adjustment of the transmission output can be implemented, for example, by using an LE set Extended Advertising Parameters command in Bluetooth (registered trademark) communication.

<LE Set Extended Advertising Parameters Command>

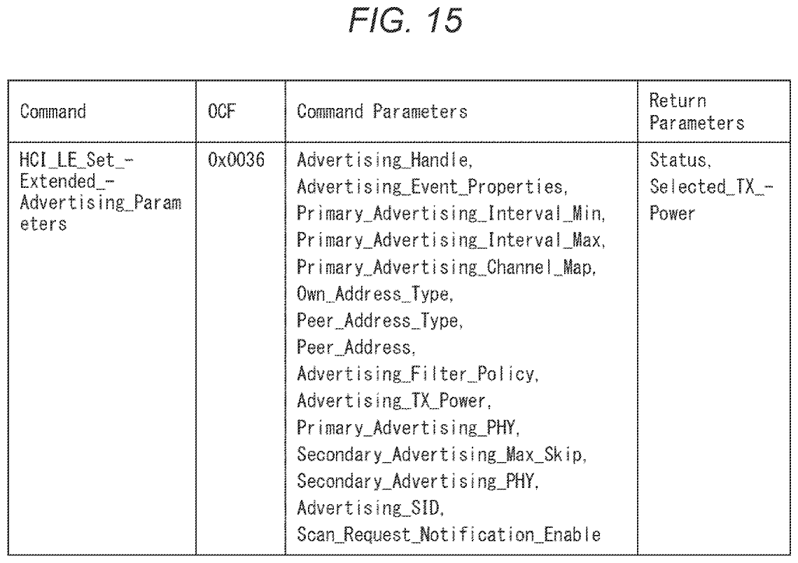

The LE set Extended Advertising Parameters command is expressed by, for example, an HCI_LE_set_Extended_-Advertising_Parameters command as illustrated in FIG. 15.

The HCI_LE_set_Extended_-Advertising_Parameters command includes, as command parameters, Advertising_Handle, Advertising_Event_Properties, Primary_Advertising_Interval_Min, Primary_Advertising_Interval_Max, Primary_Advertising_Channel_Map, Own_Address_Type, Peer_Address_Type, Peer_Address, Advertising_Filter_Policy, Advertising_TX_Power, Primary_Advertising_PHY, Seccondary_Advertising_Interval_Max_Skip, Seccondary_Advertising_PHY, Advertising_SID, and Scan_Request_Notification_Enable.

Among these, Advertising_TX_Power is a parameter for adjusting the transmission output. Accordingly, in the transmission of the drop position notification signal, when the elapsed time from the detection of the drop event exceeds a predetermined time, for example, the transmission output is reduced by adjusting the parameter set in Advertising_TX_Power.

Consequently, it is possible to extend the time during which the drop position notification signal can be transmitted, and thus, even if the elapsed time after the earphone 32 has dropped becomes long, it is possible to easily specify the direction and position of the dropped earphone 32 and to easily find it.

<Configuration Example of Earphone in Fifth Embodiment>

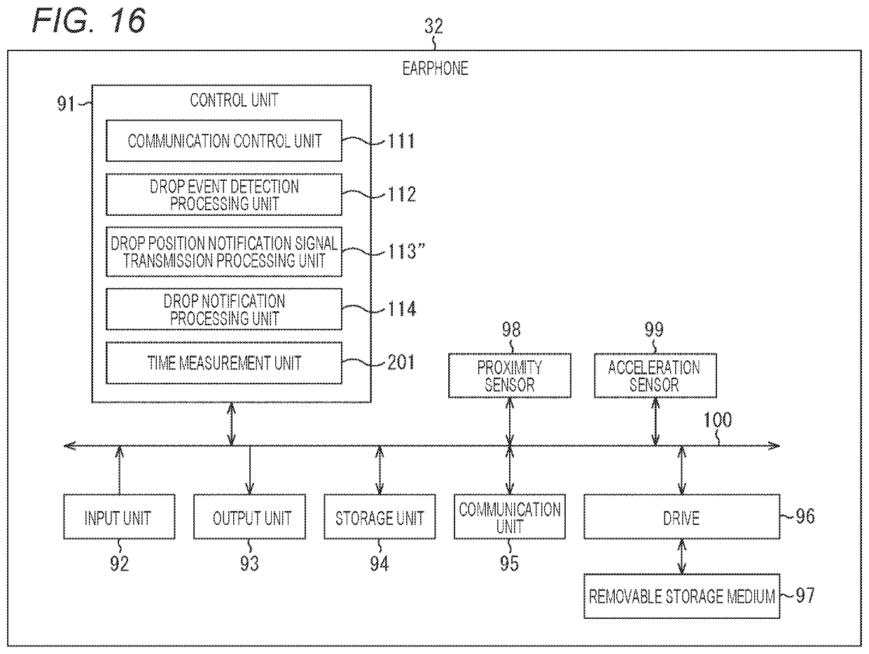

FIG. 16 illustrates a configuration example of the earphone 32 in which the drop position notification signal is transmitted with a normal transmission output until a predetermined time elapses from the detection of the drop event, and the transmission output of the drop position notification signal is reduced and transmitted after the predetermined time elapses from the detection of the drop event.

Note that the configuration of the earphone 32 in FIG. 16 is different from the earphone 32 in FIG. 4 in that a drop position notification signal transmission processing unit 113″ is provided instead of the drop position notification signal transmission processing unit 113, and a time measurement unit 201 is newly provided.

The time measurement unit 201 measures an elapsed time from the detection of the drop event.

In a case where the time measured by the time measurement unit 201 exceeds a predetermined time, for example, the drop position notification signal transmission processing unit 113″ reduces the transmission output by adjusting Advertising_TX_Power described with reference to FIG. 15 and transmits the dropping position notification signal. Note that, hereinafter, a communication mode for reducing the transmission output and transmitting the drop position notification signal by adjusting Advertising_TX_Power is referred to as a low power communication mode.

<Drop Notification Processing in Fifth Embodiment>

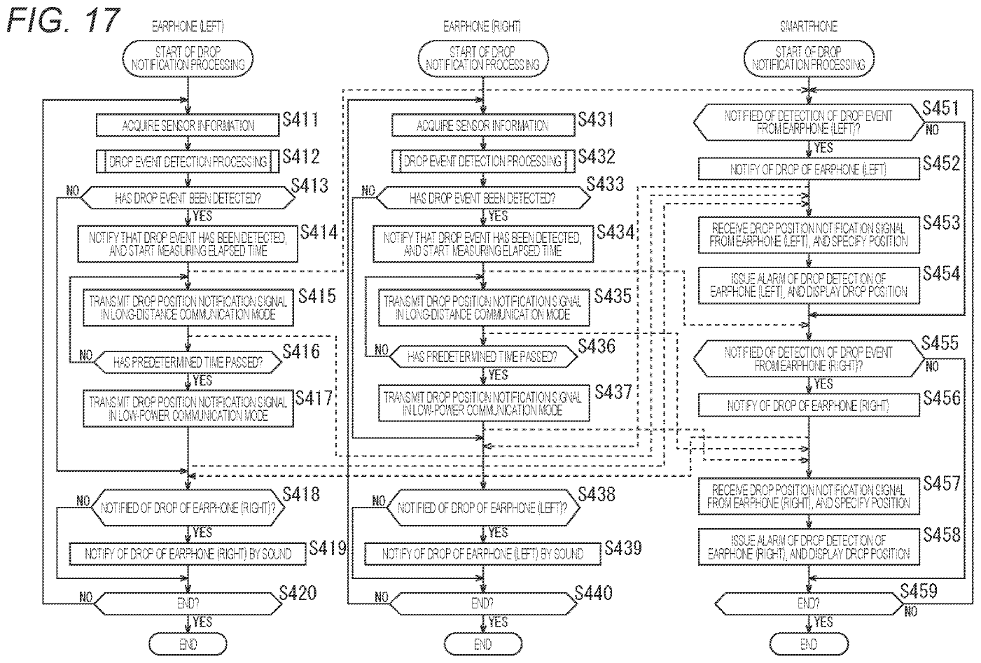

Next, drop notification processing in the fifth embodiment will be described with reference to a flowchart in FIG. 17.

Note that processing of steps S411 to S413 and S418 to S420, processing of steps S431 to S433 and S438 to S440, and processing of steps S451 to S459 in the flowchart of FIG. 17 are similar to the processing of steps S11 to S13 and S18 to S20, the processing of steps S31 to S33 and S38 to S40, and the processing of steps S51 to S59 in the flowchart of FIG. 5, and thus the description thereof is omitted.

That is, in the earphone 32L, in a case where it is determined in step S413 that a drop event has been detected, the processing proceeds to step S414.

In step S414, the drop event detection processing unit 112 controls the communication unit 95 to notify the smartphone 31 that the drop event of the earphone 32L has been detected. At this time, the time measurement unit 201 starts measuring time.

In step S415, the drop position notification signal transmission processing unit 113″ of the earphone 32L controls the communication unit 95 to start transmission of the drop position notification signal to the smartphone 31 in the long-distance communication mode using LE Coded Phy in the BLE communication, for example.

In step S416, the drop position notification signal transmission processing unit 113″ determines whether or not the elapsed time from the detection of the drop event measured by the time measurement unit 201 has passed the predetermined time.

In a case where it is determined in step S416 that the elapsed time from the detection of the drop event has not passed the predetermined time, the processing returns to step S415.

That is, until the elapsed time from the detection of the drop event passes the predetermined time, the drop position notification signal transmission processing unit 113″ transmits the drop position notification signal to the smartphone 31 in the long-distance communication mode with the normal transmission output.

Then, in a case where it is determined in step S416 that the elapsed time from the detection of the drop event has passed the predetermined time, the processing proceeds to step S417.

In step S417, the drop position notification signal transmission processing unit 113″ starts transmitting the drop position notification signal in the low power communication mode for reducing the transmission output.

Furthermore, in the earphone 32R, in a case where it is determined in step S433 that a drop event has been detected, the processing proceeds to step S434.

In step S434, the drop event detection processing unit 112 controls the communication unit 95 to notify the smartphone 31 that the drop event of the earphone 32R has been detected by the BLE communication. At this time, the time measurement unit 201 starts measuring time.

In step S435, the drop position notification signal transmission processing unit 113″ of the earphone 32R controls the communication unit 95 to start transmission of the drop position notification signal to the smartphone 31 in the long-distance communication mode using LE Coded Phy in the BLE communication, for example.

In step S436, the drop position notification signal transmission processing unit 113″ determines whether or not the elapsed time from the detection of the drop event measured by the time measurement unit 201 has passed the predetermined time.

In a case where it is determined in step S436 that the elapsed time from the detection of the drop event has not passed the predetermined time, the processing returns to step S435.

That is, until the elapsed time from the detection of the drop event passes the predetermined time, the drop position notification signal transmission processing unit 113″ transmits the drop position notification signal to the smartphone 31 in the long-distance communication mode with the normal transmission output.

Then, in a case where it is determined in step S436 that the elapsed time from the detection of the drop event has passed the predetermined time, the processing proceeds to step S437.

In step S437, the drop position notification signal transmission processing unit 113″ starts transmitting the drop position notification signal in the low power communication mode for reducing the transmission output.

By the above processing, the drop position notification signal transmission processing unit 113″ transmits the drop position notification signal to the smartphone 31 in the long-distance communication mode with normal output until a predetermined elapsed time after the detection of the drop event.

Then, after a predetermined elapsed time has elapsed since the detection of the drop event, the drop position notification signal transmission processing unit 113″ transmits the drop position notification signal to the smartphone 31 in the low power communication mode for reducing the transmission output.

By this processing, until the predetermined time elapses after the detection of the drop event, the drop position notification signal is transmitted from the earphone 32 to the smartphone 31 with the normal transmission output.

Thus, immediately after the drop event is detected, there is a high possibility that the user carrying the smartphone 31 is present at a position close to the earphone 32 that has just dropped. Thus, it is possible to immediately specify the position of the earphone 32, and it is possible to quickly find the earphone 32.

Furthermore, after the predetermined time has elapsed since the detection of the drop event, a drop position notification signal is transmitted from the earphone 32 to the smartphone 31 in the low power communication mode in which the transmission output is reduced.

Generally, after the predetermined time has elapsed since the detection of the drop event, there is a high possibility that the user carrying the smartphone 31 has moved away from the earphone 32 to such an extent that the drop position notification signal cannot be received.

For this reason, there is a possibility that it takes time for the user carrying the smartphone 31 to return to the position of the earphone 32 while thinking about his/her behavior, and there is a possibility that the drop position notification signal cannot be transmitted due to battery exhaustion if the drop position notification signal is continuously transmitted with normal transmission output.

However, by the above-described processing, after the predetermined time has elapsed since the detection of the drop event, the drop position notification signal is transmitted from the earphone 32 to the smartphone 31 in the low power communication mode in which the transmission output is reduced.

Thus, the consumption of the battery can be reduced, and the drop position notification signal can be continuously transmitted for a longer time.

Consequently, even if it takes time for the user carrying the smartphone 31 to return to the position of the earphone 32 while thinking about his/her behavior, there is a high possibility that the direction and position of the earphone 32 can be specified, and thus it is possible to easily find the earphone 32.

### 7. Example Executed by Software

Meanwhile, the above-described series of processing can be executed by hardware, but can also be executed by software. In a case where the series of processing are executed by software, a program constituting the software is installed from a recording medium into a computer built into dedicated hardware or, for example, a general-purpose computer that is capable of executing various functions by installing various programs, or the like.

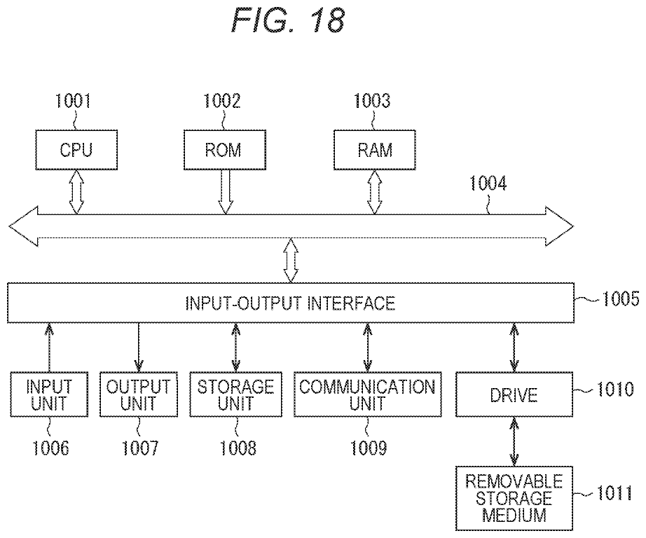

FIG. 18 illustrates a configuration example of a general-purpose computer. This personal computer includes a central processing unit (CPU) 1001. An input-output interface 1005 is connected to the CPU 1001 via a bus 1004. A read only memory (ROM) 1002 and a random access memory (RAM) 1003 are connected to the bus 1004.

To the input-output interface 1005, an input unit 1006 including an input device such as a keyboard and a mouse by which a user inputs operation commands, an output unit 1007 that outputs a processing operation screen and an image of a processing result to a display device, a storage unit 1008 that includes a hard disk drive and the like and stores programs and various data, and a communication unit 1009 including a local area network (LAN) adapter or the like and executes a communication process via a network represented by the Internet are connected. Furthermore, a drive 1010 that reads and writes data from and to a removable storage medium 1011 such as a magnetic disk (including a flexible disk), an optical disk (including a compact disc-read only memory (CD-ROM), a digital versatile disc (DVD)), a magneto-optical disk (including a Mini Disc (MD)), or a semiconductor memory is connected.

The CPU 1001 executes various processes according to a program stored in the ROM 1002 or a program read from a removable storage medium 1011 such as a magnetic disk, an optical disk, a magneto-optical disk, or a semiconductor memory, installed in the storage unit 1008, and loaded from the storage unit 1008 to the RAM 1003. The RAM 1003 also appropriately stores data necessary for the CPU 1001 to execute various processes, and the like.

In the computer configured as described above, for example, the CPU 1001 loads the program stored in the storage unit 1008 into the RAM 1003 via the input-output interface 1005 and the bus 1004 and executes the program, to thereby perform the above-described series of processes.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input-output interface 1005 by mounting the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program for processing in time series in the order described in the present description, or a program for processing in parallel or at a necessary timing such as when a call is made.

Note that the CPU 1001 in FIG. 18 implements the functions of the control unit 51 of the smartphone 31 in FIGS. 3, 7, and 9 and the control unit 91 of the earphone 32 in FIGS. 4, 10, 13, and 16.

Furthermore, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Note that embodiments of the present disclosure are not limited to the above-described embodiments, and various modifications are possible without departing from the scope of the present disclosure.

For example, the present disclosure can have a configuration of cloud computing in which one function is shared by a plurality of devices via a network and processing is performed in cooperation.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

Note that the present disclosure can also have the following configurations.
<1> A communication device, including:
a drop detection unit that detects presence or absence of a drop of an own device and transmits a notification indicating the drop when the drop is detected.
<2> The communication device according to <1>, further including:
a proximity sensor that detects whether or not the own device and a human body are in a proximity state; and
an acceleration sensor that detects acceleration of the own device, in which
the drop detection unit detects the drop in a case where the proximity sensor detects that the own device is not in proximity to the human body on the basis of a detection result of the proximity sensor and a detection result of the acceleration sensor, and the drop is detected from time-series information of acceleration detected by the acceleration sensor.
<3> The communication device according to <2>, in which
the drop detection unit detects the drop on the basis of an analysis result obtained by analyzing the detection result of the proximity sensor and the detection result of the acceleration sensor by a deep neural network (DNN).
<4> The communication device according to <3>, in which
the drop detection unit is an audio analysis engine including the DNN.
<5> The communication device according to <2>, in which
the drop detection unit transmits the notification indicating the drop to another communication device paired with the own device.
<6> The communication device according to any one of <1> to <5>, further including:
a communication unit that receives audio data transmitted from another communication device; and
an output unit that outputs sound on the basis of the audio data received by the communication unit, in which
the drop detection unit transmits the notification indicating the drop to the other communication device.
<7> The communication device according to <6>, in which
the communication unit receives the audio data transmitted from the other communication device by Bluetooth (registered trademark) communication.
<8> The communication device according to <6>, further including
a drop position notification signal transmission unit that transmits a drop position notification signal for estimating a position of the own device to the other communication device.
<9> The communication device according to <8>, in which
the drop position notification signal transmission unit transmits the drop position notification signal to the other communication device by Bluetooth low energy (BLE) communication.
<10> The communication device according to <9>, in which
a direction indicating the position of the own device is estimated by BLE Angle of Arrival (AoA) using the drop position notification signal, or the position of the own device is estimated by BLE Angle of Departure (AoD) using the drop position notification signal.
<11> The communication device according to <8>, in which
the drop position notification signal transmission unit transmits the drop position notification signal to the other communication device in a long-distance communication mode.
<12> The communication device according to <8>, in which
the drop position notification signal transmission unit transmits the drop position notification signal to the other communication device in a low power communication mode.
<13> The communication device according to <12>, in which
the drop position notification signal transmission unit transmits the drop position notification signal to the other communication device in the low power communication mode when an elapsed time from a timing at which the drop is detected by the drop detection unit becomes longer than a predetermined time.
<14> A communication method, including the step of detecting presence or absence of a drop of an own device, and transmitting, when the drop is detected, a notification indicating that the drop has been detected.
<15> A program for causing a computer to function as
a drop detection unit that detects presence or absence of a drop of an own device, and transmits, when the drop is detected, a notification indicating that the drop has been detected.
<16> A communication device, including:
a reception unit that receives a notification indicating that a drop has been detected from another communication device; and
a presentation unit that presents, on the basis of the notification, information indicating that the drop of the other communication device has been detected.
<17> The communication device according to <16>, further including
a specification unit that specifies a direction or a position of the other communication device on the basis of a drop position notification signal from the other communication device in which the drop has been detected, in which
the presentation unit presents information indicating that the drop of the other communication device has been detected, and presents the direction or the position of the other communication device specified by the specification unit.
<18> A communication method, including the steps of:
receiving a notification indicating that a drop has been detected from another communication device; and
presenting, on the basis of the notification, information indicating that the drop of the other communication device has been detected.
<19> A program for causing a computer to function as
a reception unit that receives a notification indicating that a drop has been detected from another communication device; and
a presentation unit that presents, on the basis of the notification, information indicating that the drop of the other communication device has been detected.
<20> A communication system, including a first communication device and a second communication device that communicate with each other, in which
the first communication device includes
a drop detection unit that detects presence or absence of a drop of an own device and transmits a notification indicating that the drop has been detected to the second communication device when the drop is detected, and
the second communication device includes
a reception unit that receives the notification indicating that the drop has been detected from the first communication device, and
a presentation unit that presents, on the basis of the notification, information indicating that the drop of the first communication device has been detected.

### REFERENCE SIGNS LIST

11 Communication system
31 Smartphone
32, 32L, 32R Earphone
51 Control unit
71 Communication control unit
72, 72′, 72″ Drop notification processing unit
73, 73′, 73″ Drop position specification processing unit
91 Control unit
111 Communication processing unit
112, 112′ Drop event detection processing unit
113, 113′, 113″ Drop position notification signal transmission processing unit
113, 114′ Drop notification processing unit

1. A communication device, comprising
a drop detection unit that detects presence or absence of a drop of an own device and transmits a notification indicating the drop when the drop is detected.

2. The communication device according to claim 1, further comprising:
a proximity sensor that detects whether or not the own device and a human body are in a proximity state; and
an acceleration sensor that detects acceleration of the own device, wherein
the drop detection unit detects the drop in a case where the proximity sensor detects that the own device is not in proximity to the human body on a basis of a detection result of the proximity sensor and a detection result of the acceleration sensor, and the drop is detected from time-series information of acceleration detected by the acceleration sensor.

3. The communication device according to claim 2, wherein
the drop detection unit detects the drop on a basis of an analysis result obtained by analyzing the detection result of the proximity sensor and the detection result of the acceleration sensor by a deep neural network (DNN).

4. The communication device according to claim 3, wherein
the drop detection unit is an audio analysis engine including the DNN.

5. The communication device according to claim 2, wherein
the drop detection unit transmits the notification indicating the drop to another communication device paired with the own device.

6. The communication device according to claim 1, further comprising:
a communication unit that receives audio data transmitted from another communication device; and
an output unit that outputs sound on a basis of the audio data received by the communication unit, wherein
the drop detection unit transmits the notification indicating the drop to the other communication device.

7. The communication device according to claim 6, wherein
the communication unit receives the audio data transmitted from the other communication device by Bluetooth (registered trademark) communication.

8. The communication device according to claim 6, further comprising
a drop position notification signal transmission unit that transmits a drop position notification signal for estimating a position of the own device to the other communication device.

9. The communication device according to claim 8, wherein
the drop position notification signal transmission unit transmits the drop position notification signal to the other communication device by Bluetooth low energy (BLE) communication.

10. The communication device according to claim 9, wherein
a direction indicating the position of the own device is estimated by BLE Angle of Arrival (AoA) using the drop position notification signal, or the position of the own device is estimated by BLE Angle of Departure (AoD) using the drop position notification signal.

11. The communication device according to claim 8, wherein
the drop position notification signal transmission unit transmits the drop position notification signal to the other communication device in a long-distance communication mode.

12. The communication device according to claim 8, wherein
the drop position notification signal transmission unit transmits the drop position notification signal to the other communication device in a low power communication mode.

13. The communication device according to claim 12, wherein
the drop position notification signal transmission unit transmits the drop position notification signal to the other communication device in the low power communication mode when an elapsed time from a timing at which the drop is detected by the drop detection unit becomes longer than a predetermined time.

14. A communication method, comprising the step of detecting presence or absence of a drop of an own device, and transmitting, when the drop is detected, a notification indicating that the drop has been detected.

15. A program for causing a computer to function as
a drop detection unit that detects presence or absence of a drop of an own device, and transmits, when the drop is detected, a notification indicating that the drop has been detected.

16. A communication device, comprising:
a reception unit that receives a notification indicating that a drop has been detected from another communication device; and
a presentation unit that presents, on a basis of the notification, information indicating that the drop of the other communication device has been detected.

17. The communication device according to claim 16, further comprising
a specification unit that specifies a direction or a position of the other communication device on a basis of a drop position notification signal from the other communication device in which the drop has been detected, wherein
the presentation unit presents information indicating that the drop of the other communication device has been detected, and presents the direction or the position of the other communication device specified by the specification unit.

18. A communication method, comprising the steps of:
receiving a notification indicating that a drop has been detected from another communication device; and
presenting, on a basis of the notification, information indicating that the drop of the other communication device has been detected.

19. A program for causing a computer to function as:
a reception unit that receives a notification indicating that a drop has been detected from another communication device; and
a presentation unit that presents, on a basis of the notification, information indicating that the drop of the other communication device has been detected.

20. A communication system comprising a first communication device and a second communication device that communicate with each other, wherein
the first communication device includes
a drop detection unit that detects presence or absence of a drop of an own device and transmits a notification indicating that the drop has been detected to the second communication device when the drop is detected, and
the second communication device includes
a reception unit that receives the notification indicating that the drop has been detected from the first communication device, and
a presentation unit that presents, on a basis of the notification, information indicating that the drop of the first communication device has been detected.
